(19) United States
(12) Patent Application Publication
(10) Pub. No.: US 2002/0112477 A1
(43) Pub. Date: Aug. 22, 2002

(54) Bicycle drive mechanism

(76) Inventor: Gin-Lian Cheng, Taichung (TW)

Correspondence Address: Gin-Lian Cheng, 58, MA YUAN WEST ST., TAICHUNG, TW

(21) Appl. No.: 09/793,804

(22) Filed: Feb. 22, 2001

(51) Int. Cl. F16D 31/02

(52) U.S. Cl. 60/484

(57) ABSTRACT

A bicycle drive mechanism has an oil pressure pump, two crank arms disposed on the oil pressure pump, a first three-way pipe connected to the oil pressure pump, a second three-way pipe connected to the oil pressure pump, a first oil pressure motor, a second oil pressure motor, a first oil pipe connected to the first three-way pipe and the first oil pressure motor, a second oil pipe connected to the second three-way pipe and the first oil pressure motor, a third oil pipe connected to the first three-way pipe and the second oil pressure motor, and a fourth oil pipe connected to the second three-way pipe and the second oil pressure motor.

### BACKGROUND OF THE INVENTION

The present invention relates to a bicycle drive mechanism, and more particularly to a bicycle drive mechanism which has an oil pressure pump and two oil pressure motors to drive a bicycle.

Referring to FIG. 1, a conventional bicycle drive mechanism has a chain wheel 13, a sprocket wheel 15, a drive chain 14 surrounding the chain wheel 13 and the sprocket wheel 15, and a crank arm 12 connected to the chain wheel 13. The structure of the conventional bicycle drive mechanism is complex and the drive chain 14 is easily broken.

### SUMMARY OF THE INVENTION

An object of the present invention is to provide a bicycle drive mechanism which has an oil pressure pump and two oil pressure motors to drive a bicycle.

Another object of the present invention is to provide a bicycle drive mechanism which has two speed variators to change a speed of a bicycle.

Accordingly, a bicycle drive mechanism comprises an oil pressure pump, two crank arms disposed on the oil pressure pump, a first three-way pipe connected to the oil pressure pump, a second three-way pipe connected to the oil pressure pump, a first oil pressure motor, a second oil pressure motor, a first oil pipe connected to the first three-way pipe and the first oil pressure motor, a second oil pipe connected to the second three-way pipe and the first oil pressure motor, a third oil pipe connected to the first three-way pipe and the second oil pressure motor, and a fourth oil pipe connected to the second three-way pipe and the second oil pressure motor.

### BRIEF DESCRIPTION OF THE DRAWINGS

FIG. 1 is a perspective view of a conventional bicycle drive mechanism of the prior art disposed on a bicycle;

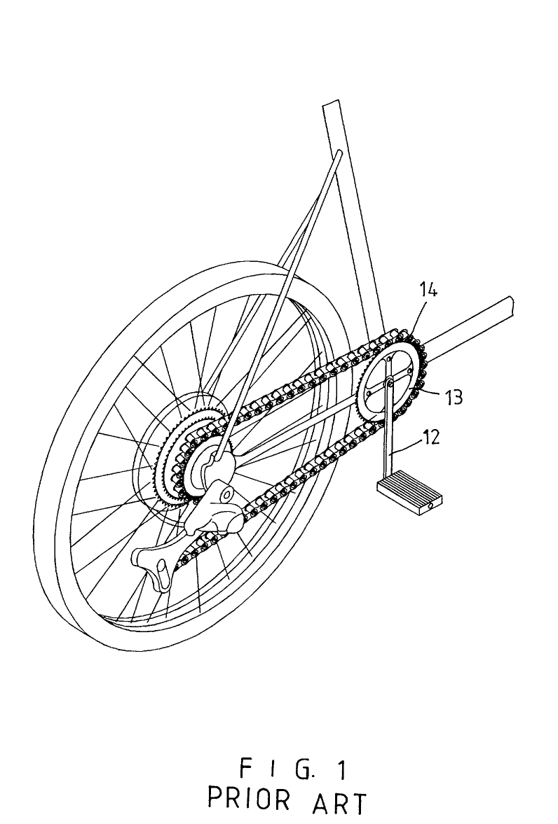

FIG. 2 is a perspective view of a bicycle drive mechanism of a preferred embodiment disposed on a bicycle; and

FIG. 3 is a perspective assembly view of a bicycle drive mechanism of a preferred embodiment in accordance with the present invention.

### DETAILED DESCRIPTION OF THE INVENTION

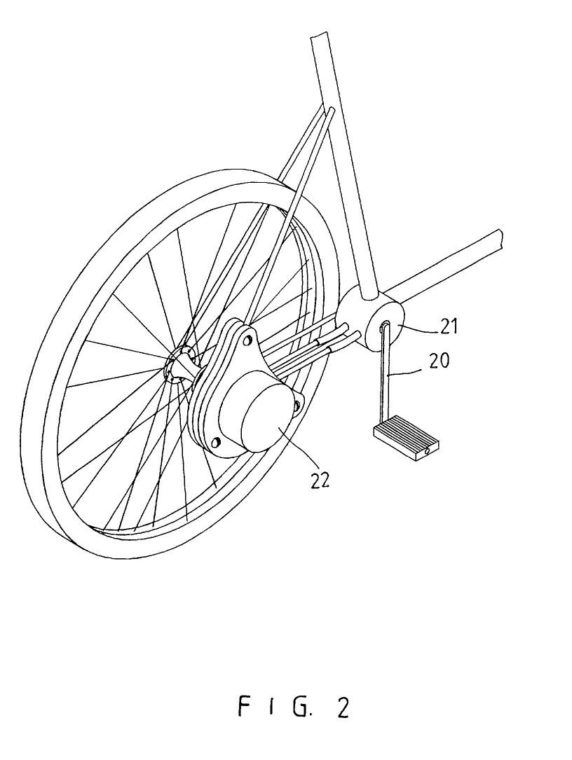

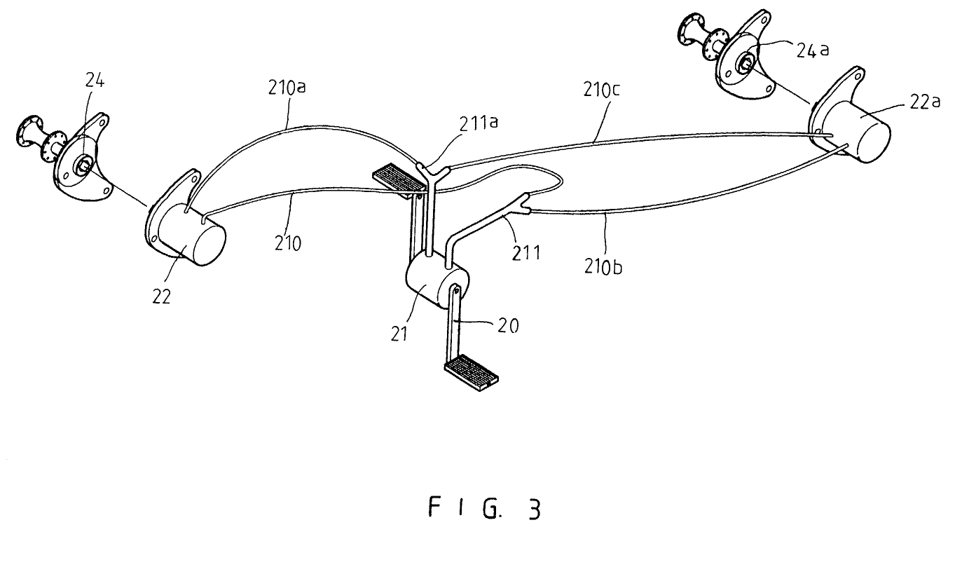

Referring to FIGS. 2 and 3, a bicycle drive mechanism comprises an oil pressure pump 21, two crank arms 20 disposed on the oil pressure pump 21, a first three-way pipe 211 connected to the oil pressure pump 21, a second three-way pipe 211a connected to the oil pressure pump 21, a first oil pressure motor 22, a second oil pressure motor 22a, a first oil pipe 210 connected to the first three-way pipe 211 and the first oil pressure motor 22, a second oil pipe 210a connected to the second three-way pipe 211a and the first oil pressure motor 22, a third oil pipe 210b connected to the first three-way pipe 211 and the second oil pressure motor 22a, and a fourth oil pipe 210c connected to the second three-way pipe 211a and the second oil pressure motor 22a.

A first speed variator 24 engages with the first oil pressure motor 22.

A second speed variator 24a engages with the second oil pressure motor 22a.

The invention is not limited to the above embodiment but various modification thereof may be made. Further, various changes in form and detail may be made without departing from the scope of the invention.

I claim:

1. A bicycle drive mechanism comprises:
an oil pressure pump,
two crank arms disposed on the oil pressure pump,
a first three-way pipe connected to the oil pressure pump,
a second three-way pipe connected to the oil pressure pump,
a first oil pressure motor,
a second oil pressure motor,
a first oil pipe connected to the first three-way pipe and the first oil pressure motor,
a second oil pipe connected to the second three-way pipe and the first oil pressure motor,
a third oil pipe connected to the first three-way pipe and the second oil pressure motor, and
a fourth oil pipe connected to the second three-way pipe and the second oil pressure motor.

2. The bicycle drive mechanism as claimed in claim 1, wherein a first speed variator engages with the first oil pressure motor.

3. The bicycle drive mechanism as claimed in claim 1, wherein a second speed variator engages with the second oil pressure motor.
